(19) United States
(12) Patent Application Publication
(10) Pub. No.: US 2007/0263938 A1
(43) Pub. Date: Nov. 15, 2007

(54) Visual entropy gain for wavelet image coding

(75) Inventors: Sang-hoon Lee, Seoul (KR); Hyung-keuk Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/710,417

(22) Filed: Feb. 26, 2007

Related U.S. Application Data
(60) Provisional application No. 60/776,231, filed on Feb. 24, 2006.

(30) Foreign Application Priority Data
Nov. 3, 2006 (KR) 10-2006-0108389

(51) Int. Cl. G06K 9/36

(52) U.S. Cl. 382/240; 382/248

(57) ABSTRACT

Provided is a method and apparatus for coding a wavelet transformed image in consideration of the human visual system (HVS) in frequency and spatial domains. A visual weight is generated by calculating the product of a spatial domain weight, which is generated by using a local bandwidth normalized according to the HVS, and a frequency domain weight generated by using an error sensitivity of a subband in a wavelet domain. Wavelet coefficients are coded and transmitted according to a coding order determined on the basis of the generated visual weight, thereby providing an image with improved visual quality at low channel capacity.

### CROSS-REFERENCE TO RELATED PATENT APPLICATION

This application claims the benefit of Korean Patent Application No. 10-2006-0108389, filed on Nov. 3, 2006, in the Korean Intellectual Property Office, and the benefit of U.S. Provisional Patent Application No. 60/776,231, filed on Feb. 24, 2006, in the U.S. Patent and Trademark Office, the disclosures of which are incorporated herein in their entirety by reference.

### BACKGROUND OF THE INVENTION

1. Field of the Invention

The present invention relates to an image coding/decoding method and apparatus, and more particularly, to an image coding method and apparatus for coding a wavelet transformed image by using a visual weight determined in consideration of a human visual system (HVS) in frequency and spatial domains, and an image decoding method and apparatus.

2. Description of the Related Art

The ongoing channel capacity increase in broadband wireless networks has resulted in extensive efforts to adapt higher quality image/video applications to the wireless network domain. Due to the dynamic characteristics of channels, it may not be possible to acquire sufficient bandwidth for sending overall traffic. In order to achieve efficient channel adaptation, most object oriented or layered coding algorithms improve subjective quality by assigning additional coding resources to interesting objects or regions.

In the past few years, several wavelet-based image compression algorithms have been proposed. The conventional wavelet-based image compression algorithm utilizes correlations between coefficients in each band. Well-known compression algorithms of wavelet coefficients are embedded image coding using the zero-trees of wavelet coefficients (EZW) and set partitioning in hierarchical trees (SPIHT) algorithms.

The hierarchical structure of the wavelet decomposition provides a better framework for capturing global features from an image sequence. That is, since the wavelet domain has a hierarchical structure in which spatial domain information and frequency domain information can be simultaneously assessed, it is useful to access overall image features from single subband information. In addition, since the wavelet domain basically has a multi-resolution feature, image coding based on the wavelet framework is preferable when it is applied to a progressive image coder.

In the human retina, the spatial distribution of photoreceptors is non-uniform. That is, the photoreceptors are concentrated most densely along the fovea, and this density rapidly decreases with distance from the fovea. Hence, a local visual frequency bandwidth detected by the photoreceptors also falls away with distance from the fovea.

Conventional image coders have mainly focused on improving the quality of a subjective image by increasing the channel throughput of visually important information, in consideration of a feature of the human visual system (HVS), but a specific reference value has not been presented to select the visually important information in consideration of the spatial and visual resolutions of the HVS.

### SUMMARY OF THE INVENTION

The present invention provides an image coding method and apparatus in which visual weights of wavelet transform coefficients are set in consideration of the sensitivity of the human visual system (HVS) in spatial and frequency domains, and a coding order of the wavelet transform coefficients is determined on the basis of the visual weights, thereby improving the quality of a coded image at low channel capacity, and an image decoding method and apparatus.

According to an aspect of the present invention, there is provided an image coding method comprising: generating wavelet transform coefficients by transforming an input image; generating visual weights of the wavelet transform coefficients in consideration of the sensitivity of a human visual system (HVS) in spatial and frequency domains; determining a coding order of the wavelet transform coefficients by using the generated visual weights; and coding the wavelet transform coefficients according to the determined coding order.

According to another aspect of the present invention, there is provided an image coding apparatus comprising: a transformer generating wavelet transform coefficients by transforming an input image; a visual weight generator generating visual weights of the wavelet transform coefficients in consideration of the sensitivity of a human visual system (HVS) in spatial and frequency domains; a coding order determining unit determining a coding order of the wavelet transform coefficients by using the generated visual weights; and a sequential wavelet coefficient coder coding the wavelet transform coefficients according to the determined coding order.

According to another aspect of the present invention, there is provided an image decoding method comprising: decoding wavelet transform coefficients coded in the order of the magnitudes of visual weights generated in consideration of the sensitivity of a human visual system (HVS) in spatial and frequency domains; performing an inverse wavelet transform on the decoded wavelet transform coefficients; and reconstructing an image by using the inverse-wavelet-transformed coefficients of each subband.

According to another aspect of the present invention, there is provided an image decoding apparatus comprising: a sequential wavelet coefficient decoder decoding wavelet transform coefficients coded in the order of the magnitudes of visual weights generated in consideration of the sensitivity of a human visual system (HVS) in spatial and frequency domains; an inverse transformer performing an inverse wavelet transform on the decoded wavelet transform coefficients; and an image reconstruction unit reconstructing an image by using the inverse-wavelet-transformed coefficients of each subband.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B respectively illustrate examples of an original image a(x) and a foveated image ã(x);

FIGS. 2A and 2B respectively illustrate an original image b(Φ(X)) and a foveated image \tilde{b}(Φ(x)) which are obtained by mapping the original image a(x) illustrated in FIG. 1A and the foveated image ã(x) illustrated in FIG. 1B over the curvilinear coordinates Φ(x);

FIG. 3 illustrates a typical retinal eccentricity and a viewing geometry;

FIG. 4 illustrates a wavelet decomposition structure;

FIG. 5 is a block diagram of an image coding apparatus according to an embodiment of the present invention;

FIG. 6 is a flowchart of an image coding method according to an embodiment of the present invention;

FIG. 7 is a block diagram illustrating a structure of an image decoding apparatus according to an embodiment of the present invention;

FIG. 8 is a flowchart illustrating an image decoding method according to an embodiment of the present invention;

FIG. 9A illustrates images coded and reconstructed by the conventional set partitioning in hierarchical trees (SPIHT) algorithm when image quality is measured according to a target bit rate;

FIG. 9B illustrates images coded and reconstructed in the order of the magnitudes of visual weights of the present invention when image quality is measured according to a target bit rate;

FIG. 10 is a graph illustrating the amount of transmitted visual entropy when using a method in which transmission is performed by reorganizing wavelet coefficients with reference to visual weights according to channel capacity of (1) an embodiment of the present invention and (2) a method in which transmission is performed according to the conventional SPIHT algorithm, against channel capacity relative to a linear projection; and

FIG. 11 is a graph illustrating a visual entropy gain when transmission is made by reorganizing wavelet coefficients with reference to visual weights according to channel capacity of an embodiment of the present invention, and when transmission is made according to the conventional SPIHT algorithm.

### DETAILED DESCRIPTION OF THE INVENTION

Hereinafter, for easy understating of visual entropy used for determining visual weights of wavelet transform coefficients in consideration of the sensitivity of the human visual system (HVS) in spatial and frequency domains, a definition of entropy, visual entropy in a spatial domain, and visual entropy in a wavelet domain will be first described, followed by the description of an image coding/decoding method and apparatus.

Definition of Entropy

In the process of image coding, a scalar quantizer Q quantizes a random variable X having a real number so as to generate a quantized variable \hat{X}. If the variable X exists in the range of [y₋,y₊], and the range of [y₋,y₊] is divided into M intervals, then each interval is expressed by [yₘ₋₁, yₘ](1≦m≦M, y₀=y₋, y_{M}=y₊). In this case, if xε[yₘ₋₁, yₘ], then Q(x)=xₘ. It will be assumed that a probability pₘ of an m^{th} value in each of the M intervals is expressed by pₘ=P{Xε[yₘ₋₁, yₘ]}=Pr(\hat{X}=xₘ). Then, entropy H(\hat{X}) of the quantized random variable \hat{X} is expressed by

$$H ( \hat{X} ) = - {\sum }_{m = 1}^{M} {p}_{m} {log}_{2} {p}_{m} .$$

Herein, H(\hat{X}) denotes a minimum value of an average number of bits required to code the quantized random variable X.

In general, if a probability density function (PDF) of the random variable X is P(x), differential entropy H_{d}(x) of the random variable X is expressed by Formula 1:

$${H}_{d} ( X ) = - {\int }_{- ∞}^{∞} p ( x ) {log}_{2} p ( x ) ⅆ x . \qquad Formula 1$$

If a quantization error produced in the scalar quantizer Q is defined as D, it is determined that

$$H ( \hat{X} ) \geq {H}_{d} ( X ) - \frac{1}{2} {log}_{2} ( 12 D )$$

is satisfied. In Formula 1, the equality is satisfied when the scalar quantizer Q is a uniform quantizer. That is, the uniform quantizer may be used to minimize the average number of bits required to code the quantized random variable \hat{X}. If the magnitude of a single quantization bin used in the uniform quantizer is Δ, then D=(Δ²/12), and a minimum average bit rate Rₓ is given by R_{X}=H(\hat{X})=H_{d}(X)-log₂Δ.

If a signal A can be given by

$$A = {\sum }_{m = 0}^{N - 1} a [ m ] {g}_{m}$$

(where N is the total number of samples of the signal A in a transform domain) by using transform coefficients a[m] and an orthonormal basic function gₘ, then a quantized coefficient of a[m] is â[m]=Q(a[m]), and entropy is Rₘ=H(â[m]). An optimum bit allocation process is performed in order to minimize the total number of bits R required to code the quantized transform coefficients a[m], that is,

$$R = {\sum }_{m = 0}^{N - 1} {R}_{m}$$

(Rₘ is the total number of bits required to code a[m]), where a total quantization error of a[m] is D. An average number of bits generated for each sample is given by R̅=(R/N). In this case, if it is determined that quantization errors Dₘ, that is, E(a[m]−â[m])², of the respective transform coefficients a[m] are the same as one another, then the average total number of bits generated for each sample R has a minimum value. Average differential entropy H̅_̅{̅d̅}̅ is defined by an average value, that is,

$${\overline{H}}_{d} = \frac{1}{N} {\sum }_{m = 0}^{N - 1} {H}_{d} ( a [ m ] ) ,$$

of differential entropy of N sampled transform coefficients. If the signal A is a Gaussian random value, and a dispersion of the wavelet coefficients a[m] is σ²ₘ, then entropy of Gaussian random values is expressed by Formula 2:
H_{d}(a[m])=log₂σₘ+log₂\sqrt{2πe}. Formula 2

If a[m] denotes a Laplacian random variable, then entropy of a[m] is expressed by Formula 3:
H_{d}(a[m])=log₂σₘ+log₂\sqrt{2e²}. Formula 3

Visual Entropy in the Spatial Domain

As described above, the human eye acquires visual information via a non-uniform sampling process that is consistent with the non-uniform photoreceptor density in the retina. Thus, the human eye receives non-uniform resolution visual information according to a fixation point, and a modified image is created from which undetectable high frequencies are removed by using a non-linear sampling process. The modified image is defined as a foveated image.

In general, the fixation point can be a point, multiple points, an object, objects, or a certain region according to the content or the application.

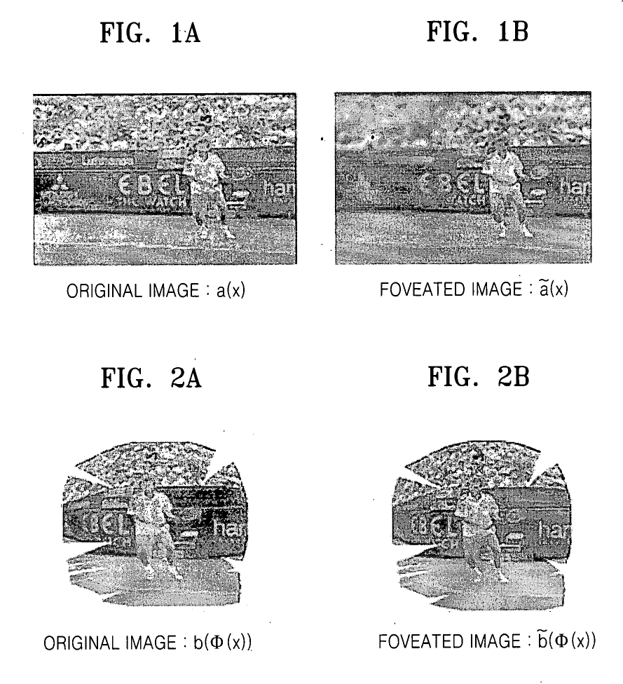

In order to compare an original image with a foveated image, FIGS. 1A and 1B respectively illustrate examples of an original image a(x) and a foveated image ã(x).

In FIGS. 1A and 1B, a tennis player is assumed to be a region of interest (ROI). In this case, a foveated region is defined as a region around the tennis player. As shown in FIG. 1B, due to a non-linear characteristic of the photoreceptors, the visual resolution perceived by the photoreceptors exponentially decays in a symmetric pattern with respect to the retina. New coordinates are obtained from such a non-linear mapping structure, and are defined as curvilinear coordinates Φ(x).

FIGS. 2A and 2B respectively illustrate an original image b(Φ(x)) and a foveated image \tilde{b}(Φ(x)) which are obtained by mapping the original image a(x) of FIG. 1A and the foveated image ã(x) of FIG. 1B over the curvilinear coordinates Φ(x). That is, the images b(Φ(x)) and \tilde{b}(Φ(x)) are obtained by coordinate-transforming the original image a(x) illustrated in FIG. 1A and the foveated image ã(x) illustrated in FIG. 1B in consideration of the concave-shaped human eye.

When comparing FIGS. 2A and 2B, the original image b(Φ(x)) and the foveated image \tilde{b}(Φ(x)) which are perceived by actual photoreceptors are almost visually equal to each other.

If a spatial domain of the original image of FIG. 1A is Sₒ⊂R², and an area corresponding to the original image in the Cartesian coordinates is Aₒ, then areas of the original image b(Φ(x)) illustrated in FIG. 2A and the foveated image \tilde{b}(Φ(x)) illustrated in FIG. 2B, which have been mapped over the curvilinear coordinates, are expressed by A_{c}=∫_{S}_{ₒ}J_{Φ}(x)dx. Herein, J_{Φ}(x) is a Jacobian function that represents a coordinate-transforming from x to Φ(x).

In a discrete domain, J̅_̅{̅Φ̅}̅(x) is proportional to the square of a local frequency fₙ² and thus is expressed by Formula 4:
J̅_̅{̅Φ̅}̅(x)=cfₙ², Formula 4
where c is a constant. If a transform coefficient of one pixel of a given image is a random variable X, H_{d}(x) is obtained by Formula 1 as mentioned above. Total differential entropy H_{d}^{T}(x) for the image is expressed by Formula 5:
H_{d}^{T}(x)=AₒH_{d}(x) Formula 5

Similarly, differential entropy H_{d}(Φ) of the foveated image \tilde{b}(Φ(x)) mapped over the curvilinear coordinates and total visual entropy H_{d}^{T}(Φ) can be expressed by Formulas 6 and 7:
H_{d}(Φ)=−∫_{Φp(φ)log}p(φ)dφ Formula 6
H_{d}^{T}=A_{c}H_{d}(Φ) Formula 7

Since both images a(x) and \tilde{b}(Φ(x)) are band-limited by a local bandwidth Ωₒ, it can be assumed that the original images a(x) and the foveated images \tilde{b}(Φ(x)) have the same probability density function and the same differential entropy. That is,
p(x)=p(φ), H_{d}(x)=H_{d}(φ)

Thus, the redundancy of information required to represent the foveated image obtained by transforming the original image mapped over the curvillinear coordinates in consideration of a human visual system (HVS) feature can be determined by using the difference between an area Aₒ of the original image and an area A_{c} of the foveated image mapped over the curvilinear coordinates. That is, when an image is encoded by using the foveated image mapped over the curvilinear coordinates, entropy is saved in an amount (Aₒ-A_{c})H(x) (here, Aₒ≧A_{c}) in comparison with encoding of the original image over the Cartesian coordinates.

Theoretically, the saved entropy corresponds to the upper boundary of image data reduction in encoding without losing any visual information. Thus, a normalized gain Gm attained when the foveated image over the curvilinear coordinates is encoded in consideration of the HVS feature can be expressed by Gm=(Aₒ−A_{c})/Aₒ.

Differential Entropy of Wavelet Coefficients

First, assume that W(X) is a wavelet transform function. In FIG. 1A, the original image a(X) is transformed into the wavelet domain. The wavelet coefficient a[m] (m is a wavelet coefficient index) is then expressed by Formula 8:
a[m]=<a(x),gₘ>=∫ₓa(x)gₘ(x)dx Formula 8

As described above, g_{.m} denotes an orthonormal basis function.

Under the assumption that b(Φ(x)) and \tilde{b}(Φ(x)) are band-limited by the local bandwidth Ωₒ, it can be approximated that b(Φ(x))=\tilde{b}(Φ(x)).

A wavelet coefficient b[m] of b(Φ(x)) can be expressed by Formula 9.
b[m]=<b(Φ(x)),gₘ>=∫ₓb(Φ(x))gₘ*(Φ(x))dΦ(x) Formula 9

By using Formulas 1 and 6, the wavelet transform coefficient a[m] in the Cartesian coordinates and the wavelet transform coefficient b[m] in the curvilinear coordinates can be expressed by Formula 10.

$${H}_{d} ( a [ m ] ) = - {\int }_{- ∞}^{∞} p ( a [ m ] ) {log}_{2} p ( a [ m ] ) ⅆ a [ m ] \\ {H}_{d} ( b [ m ] ) = - {\int }_{- ∞}^{∞} p ( b [ m ] ) {log}_{2} p ( b [ m ] ) ⅆ b [ m ] . \qquad Formula 10$$

Visual Entropy in Wavelet Domain

Assume that a visual weight Φₘ is determined in consideration of an HVS feature in the spatial and frequency domains. For a given visual weight Φₘ, visual entropy H_{d}^{ω}(a[m]) can be expressed by Formula 11.
H_{d}^{ω}(a[m])=H_{d}^{ω}(b[m])=ωₘH_{d}(a[m]) Formula 11

As described above, ωₘ is characterized by two visual components: one for the spatial domain and the other for the frequency domain.

The local frequency fₙ in Formula 4 is employed as a visual weight in the spatial domain. Let fₘ be the local frequency in the wavelet domain, fₘ is then expressed by Formula 12:
fₘ=min(f_{c}, f_{d})(cycles/deg), Formula 12
where m is the index of the wavelet coefficient a[m]. Furthermore, in Formula 12, f_{c} denotes a critical frequency, and f_{d} denotes a display Nyquist frequency. The critical frequency and the display Nyquist frequency will now be described.

Psychological experiments have been conducted to measure the contrast sensitivity as a function of the retinal eccentricity of the HVS. A model that fits the experimental data can be expressed by Formula 13:

$$CT ( f , ⅇ ) = {CT}_{0} exp ( α f \frac{ⅇ + {e}_{2}}{{e}_{2}} ) , \qquad Formula 13$$

where f is a spatial frequency (cycles/deg), e is a retinal eccentricity (degrees), CT₀ is a minimal contrast threshold, α is a spatial frequency decay constant, e₂ is a half-resolution eccentricity constant, and CT(f,e) is a visible constant threshold as a function of f and e. The contrast sensitivity CS(f,e) is defined as the inverse of the contrast threshold, that is, 1/CT(f,e).

For a given eccentricity e, Formula 13 can be used to find its critical frequency f_{c}. The critical frequency f_{c} indicates a limit in a spatial frequency component perceivable by humans. Any higher frequency component beyond the critical frequency f_{c} is invisible.

The critical frequency f_{c} expressed by Formula 14 can be obtained by setting CT(f,e) to 1 (the maximum possible contrast) in Formula 13.

$${f}_{c} = \frac{{e}_{2} ln ( \frac{1}{{CT}_{0}} )}{α ( e + {e}_{2} )} \qquad Formula 14$$

FIG. 3 illustrates a typical retinal eccentricity and a viewing geometry. For simplicity, it is assumed that an observed image plane 300 is N pixels wide and the line from the fovea to a fixation point 310 is perpendicular to the image plane 300. It is also assumed that a distance from the fovea to the observer's eye is normalized to fit an image size, and the normalized value is defined as v.

Referring to FIG. 3, the eccentricity e is defined as an angle difference between the fixation point 310 of the observer and an arbitrary point 320 indicated by x and spaced apart from the fixation point 310 by a predetermined distance u (measured by means of normalization so as to fit the image size). Thus, when the fixation point 310 in the image plane 300 is observed, the eccentricity e viewed by the observer who is in a position spaced apart from the image plane 300 by the distance v is given by

$${tan}^{- 1} ( \frac{u}{ν} ) .$$

In real-world digital images, the maximum perceived resolution is also limited by the display resolution r given by

$$r \approx \frac{π N ν}{180} ( \frac{pixels}{deg} ) .$$

According to the sampling theorem, the highest frequency that can be represented by the display device without aliasing, or a display Nyquist frequency f_{d}, is half of the display resolution r. Thus, the display Nyquist frequency f_{d} can be expressed by Formula 15:

$${f}_{d} = \frac{r}{2} \approx \frac{π N ν}{360} ( \frac{cycles}{degree} ) . \qquad Formula 15$$

In a two-dimensional spatial domain, the square of the local frequency fₘ normalized by using Formula 16 can be used as a weight ωₘ^{s} in the spatial domain.

$${ω}_{m}^{s} = {( \frac{{f}_{m}}{max ( {f}_{m} )} )}^{2} \qquad Formula 16$$

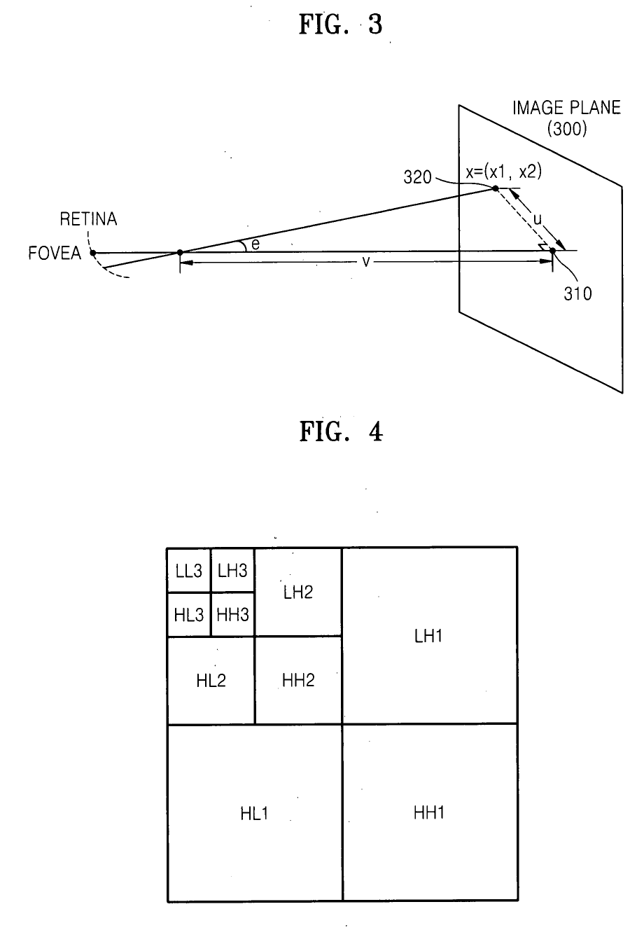

FIG. 4 illustrates a wavelet decomposition structure.

Referring to FIG. 4, the horizontal and vertical wavelet decompositions are applied alternatively, yielding, LL, HL, LH, and HH subbands. The LL subband may be further decomposed. The process may be repeated several times.

The wavelet coefficients at different subbands and locations supply information of variable perceptual importance to the HVS. There is a need for measuring the visual importance of each wavelet coefficient in the frequency domain in consideration of the HVS feature. In an embodiment of the present invention, the weight ωₘ^{f} over the frequency domain, which is a frequency domain component of the visual weight ωₘ, is determined by each wavelet subband. Experiments were conducted to measure a visually detectable noise threshold Y that can be expressed by Formula 17:
log Y=log a+k(log f−log g_{θ}fₒ)² Formula 17
where, θ is an index representing wavelet subbands, f is a spatial frequency (cycles/degree), and g_{θ}, fₒ, and k are constants. A given display resolution r and a wavelet decomposition level λ are used to obtain a spatial frequency expressed by f=r2^{-λ}.

In this case, an error detection threshold T_{λ,θ} for the wavelet coefficients at any wavelet decomposition level λ and the subband θ can be expressed by Formula 18:

$${T}_{λ , θ} = \frac{{Y}_{λ , θ}}{{A}_{λ , θ}} = \frac{{α10}^{k ( {log ( {2}^{λ} {f}_{0} {g}_{θ} / r )}^{2} )}}{{A}_{λ , θ}} , \qquad Formula 18$$

where, A_{λ,θ} is a basis function amplitude. It is typical to define an error sensitivity S_{ω}(λ,θ) at a single subband as the inverse of the error detection threshold T_{λ,θ}, that is, 1/T_{λ,θ}.

In an embodiment of the present invention, the error sensitivity S_{ω}(λ,θ) normalized by using Formula 19 is used as the weight ωₘ^{f} in the frequency domain:

$${ω}_{m}^{f} = \frac{{S}_{ω}}{max ( {S}_{ω} )} . \qquad Formula 19$$

Formulas 16 and 19 are used to finally define a visual weight ωₘ expressed by Formula 20, which is set in consideration of the HVS feature in the [[spatial]]spatial and frequency domains.
ωₘ^{t}=ωₘ^{s}·ωₘ^{f} Formula 20
Image Coding/Decoding Method and Apparatus Considering Visual Weight

Hereinafter, an image coding/decoding method using a visual weight that is the product of the spatial domain weight and the frequency domain weight mentioned above, and an image coding apparatus using the image coding/decoding method will be described.

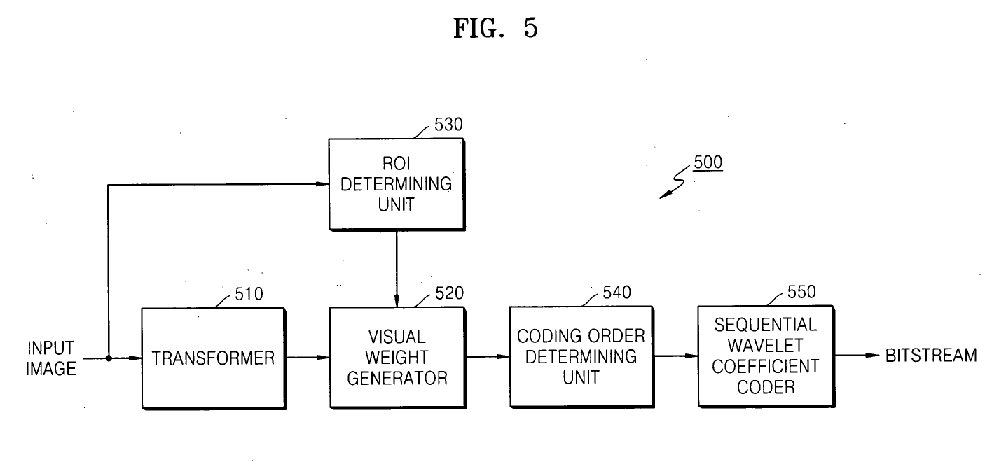

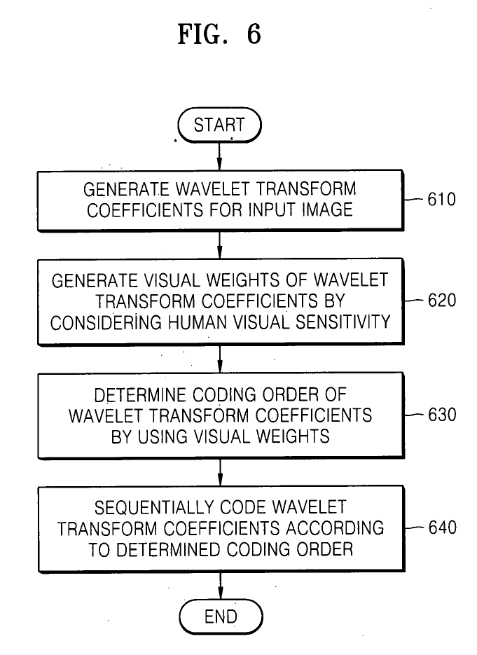

FIG. 5 is a block diagram of an image coding apparatus according to an embodiment of the present invention. FIG. 6 is a flowchart of an image coding method according to an embodiment of the present invention.

Referring to FIG. 5, an image coding apparatus 500 includes a transformer 510, a visual weight generator 520, a region of interest (ROI) determining unit 530, a coding order determining unit 540, and a sequential wavelet coefficient coder 550.

In operation 610, the transformer 510 transforms a wavelet for an input image so as to divide the input image into a low frequency subband and a high frequency subband, thereby obtaining wavelet transform coefficients for each pixel of the input image.

In operation 620, the visual weight generator 520 generates visual weights of the wavelet transform coefficients in consideration of the sensitivity of the HVS in the spatial and frequency domains.

As described above, the visual weight generator 520 may use the local frequency fₙ in Formula 4 as a visual weight in the spatial domain. Alternatively, the visual weight generator 520 may select a minimum value between a critical frequency f_{c} in the wavelet domain and a display Nyquist frequency f_{d} as a local frequency fₘ, and may use the square of the local frequency fₘ normalized by using Formula 16 as the weight ωₘ^{s} in the spatial domain. That is, the visual weight generator 520 selects a minimum value between the critical frequency expressed by

$${f}_{c} = \frac{{e}_{2} ln ( \frac{1}{{CT}_{0}} )}{α ( e + {e}_{2} )}$$

in the wavelet domain and the display Nyquist frequency expressed by

$${f}_{d} = \frac{r}{2} \approx \frac{π N ν}{360} ( \frac{cycles}{degree} )$$

as a maximum frequency that can be represented by the display device without aliasing. The selected value is normalized by using Formula 16, thereby generating the weight ωₘ^{s} in the spatial domain. Furthermore, the visual weight generator 520 normalizes the error sensitivity S_{ω}(λ,θ) having the inverse of the error detection threshold T_{λ,θ} in a subband, that is, 1/T_{λ,θ}, by using Formula 19, so as to generate the weight ωₘ^{f} in the frequency domain. Then, the visual weight generator 520 multiplies the weight ωₘ^{s} in the spatial domain by the weight ωₘ^{f} in the frequency domain, so as to generate a visual weight which is a reference value that is used for determining a coding order of the wavelet coefficients.

The ROI determining unit 530 determines a region on which the eye is fixated when generating the visual weight. Thus, the ROI determining unit 530 determines an image region visually perceived by the photoreceptors, that is, a foveated region. By using motion detection, the ROI determining unit 530 may determine the image region in which a motion or action is highly likely to be perceived. The ROI determining unit 530 may determine an ROI of the image by tracking an observer's pupil movement in a similar manner to that employed by application programs for surveillance cameras. The ROI determining unit 530 may determine a region selected by a user as the ROI.

In operation 630, the coding order determining unit 540 determines a coding order of the wavelet transform coefficients by using the generated visual weights. In operation 640, the sequential wavelet coefficient coder 550 generates a bitstream by quantizing and entropy-coding the wavelet transform coefficients according to the coding order determined by the sequential wavelet coefficient coder 550. For example, the coding order determining unit 540 uses the visual weights generated by the visual weight generator 520 to reorganize the wavelet coefficients of each subband within a single frame in the order of the magnitudes of the visual weights. Then, the sequential wavelet coefficient coder 550 codes the wavelet coefficients that are to be transmitted, starting from the one having the highest visual weight.

By using a current channel capacity and the differential entropy of the wavelet coefficients, the coding order determining unit 540 may calculate the total number of wavelet coefficients that can be transmitted with the current channel capacity, and may select the wavelet transform coefficients in the order of the magnitudes of the generated visual coefficients.

Meanwhile, the amount of delivered visual information depends on the sum of the transmitted visual entropy. To maximize the visual throughput for a limited channel capacity, it is necessary to first transmit the coefficient value containing higher importance visual information. As described above, the visual information contained in a single bit depends on a visual weight that is the product between the spatial weight and the visual weight, which is characterized by the frequency and spatial domains in consideration of the HVS feature. Formula 20 is used to define visual entropy expressed by Formula 21:
H_{d}^{ω}(a[m])=ωm^{t}H_{d}(a[m])=ωₘ^{t}(log₂σₘ+log₂\sqrt{2e²}). Formula 21

Given a channel capacity C, the total entropy of M transmitted wavelet coefficients can be expressed by Formula 22:

$${\sum }_{m = 0}^{M - 1} {H}_{d} ( a [ m ] ) = C . \qquad Formula 22$$

Let k be the index of the wavelet coefficients reorganized in the order of the magnitudes of visual weights according to an embodiment of the present invention. The transmittable visual entropy is then obtained by Formula 23:

$${\sum }_{k = 0}^{K - 1} {H}_{d} ( a [ k ] ) = C , \qquad Formula 23$$

where K denotes the maximum number of wavelet transform coefficients that can be transmitted when channel capacity is constrained to C. The visual entropy of the wavelet coefficients transmitted on the basis of visual importance can be expressed by Formula 24:

$${\sum }_{k = 0}^{K - 1} {H}_{d}^{ω} ( a [ k ] ) - {\sum }_{k = 0}^{K - 1} {ω}_{k}^{t} {H}_{d} ( a [ k ] ) = {C}_{ω} , \qquad Formula 24$$

where Cω is the sum of the delivered visual entropy for the given channel capacity C. If the visual weight ωₘ^{t} of an embodiment of the present invention is used, a relative visual entropy gain Gₜ is expressed by Formula 25:

$${G}_{t} = \frac{1}{{C}_{ω}^{T} } ( {\sum }_{k = 0}^{K - 1} {H}_{d}^{ω} ( a [ k ] ) - {\sum }_{m = 0}^{M - 1} {H}_{d}^{ω} ( a [ m ] ) ) , \qquad Formula 25$$

where

$${\sum }_{k = 0}^{\\ K - 1} {H}_{d} ( a [ k ] ) = {\sum }_{ m = 0}^{M - 1} {H}_{d} ( a [ m ] ) = C .$$

In Formula 25, C_{ω}^{T} is total visual entropy of wavelet coefficients calculated in consideration of visual weights. That is,

$${C}_{ω}^{T} = {\sum }_{m = 0}^{{M}^{T} - 1} {H}_{d}^{ω} ( a [ m ] ) ,$$

where M^{T} is the number of total wavelet coefficients.

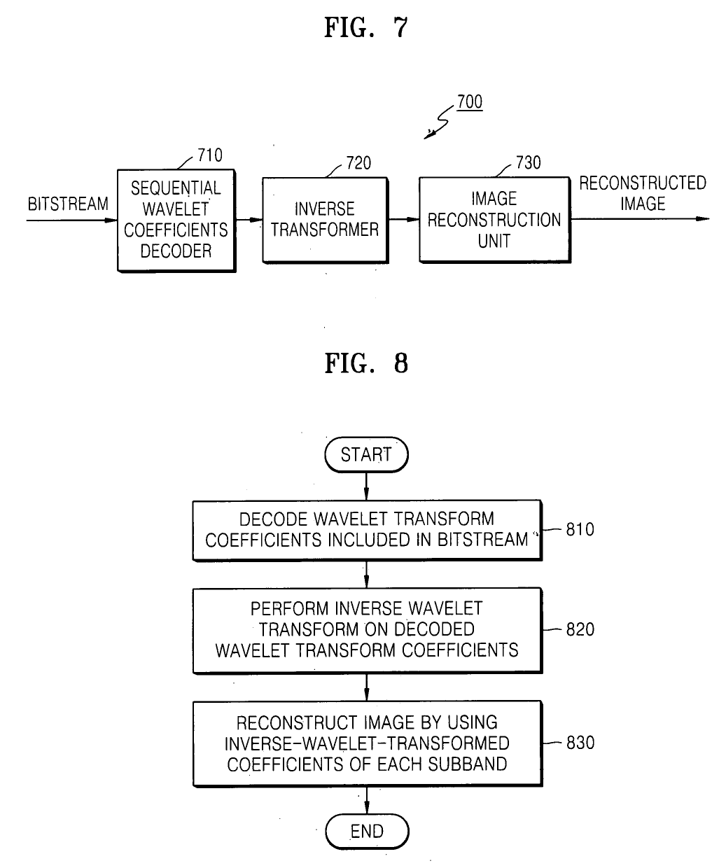

FIG. 7 is a block diagram illustrating a structure of an image decoding apparatus according to an embodiment of the present invention. FIG. 8 is a flowchart illustrating an image decoding method according to an embodiment of the present invention.

Referring to FIG. 7, an image decoding apparatus 700 includes a sequential wavelet coefficient decoder 710, an inverse transformer 720, and an image reconstruction unit 730.

In operation 810, according to the aforementioned image coding method, the sequential wavelet coefficient decoder 710 decodes wavelet transform coefficients that have been coded in the order of the magnitudes of visual weights of the wavelet transform coefficients generated in consideration of the sensitivity of the HVS in the spatial and frequency domains. That is, the sequential wavelet coefficient decoder 710 outputs wavelet transform coefficients by entropy-decoding and de-quantizing the wavelet transform coefficients included in a bitstream.

In operation 820, the inverse transformer 720 outputs wavelet coefficients of each subband by performing an inverse wavelet transformation on the decoded wavelet transform coefficients.

In operation 830, the image reconstruction unit 730 reconstructs an image by using the inverse-wavelet-transformed coefficients of each subband.

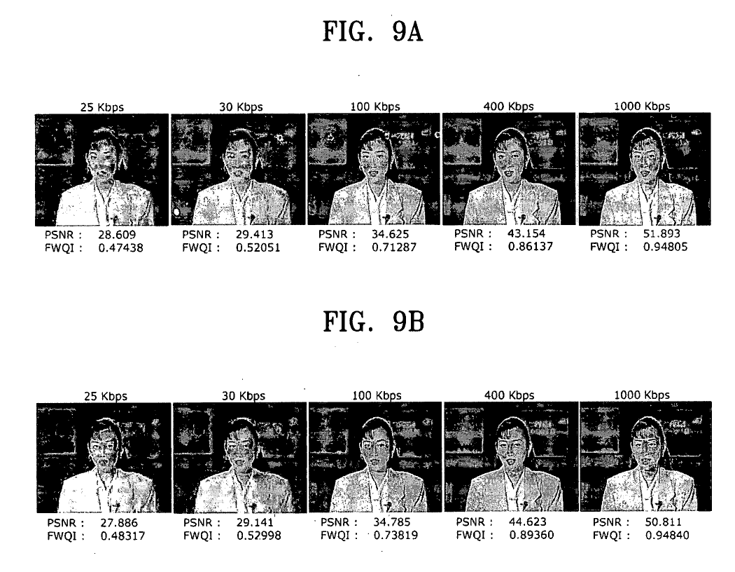

FIG. 9A illustrates images coded and reconstructed by the conventional SPIHT algorithm when image quality is measured according to a target bit rate. FIG. 9B illustrates images coded and reconstructed in the order of the magnitudes of visual weights according to an embodiment of the present invention when image quality is measured according to a target bit rate.

A peak signal to noise ratio (PSNR) and a foveated wavelet image quality index (FWQI) are used as units of quality measurement. The FWQI is disclosed in “A universal image quality index (Z. Wang and A. C. Bovik, IEEE Signal Processing Letters)” in greater detail, and thus a detailed description thereof will be omitted.

FIGS. 9A and 9B show that the visual quality of the images coded and reconstructed with reference to visual weights according to an embodiment of the present invention is remarkably improved compared to the images coded and reconstructed by using the conventional SPIHT algorithm. As the bit rate increases, the number of transmittable wavelet coefficients increases. Thus, an embodiment of the present invention can provide an image with improved visual quality, in particular, at a low channel bandwidth.

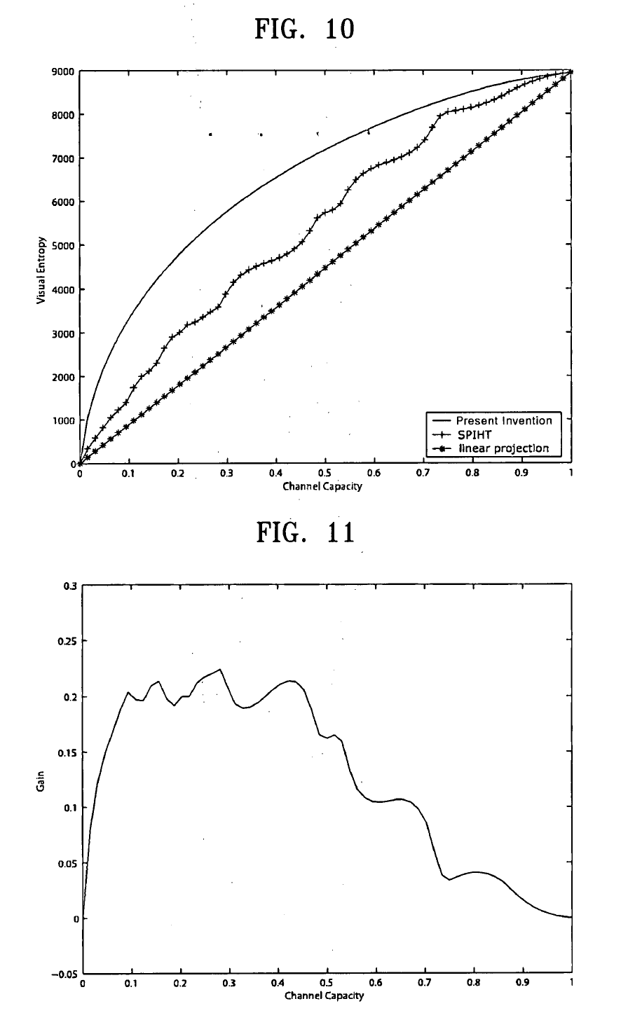

FIG. 10 is a graph illustrating the amount of transmitted visual entropy when using a method in which transmission is performed by reorganizing wavelet coefficients with reference to visual weights according to a channel capacity according to an embodiment of the present invention and a method in which transmission is performed according to the conventional SPIHT algorithm, against channel capacity relative to a linear projection. FIG. 11 is a graph illustrating a visual entropy gain defined in Formula 25 when transmission is performed by reorganizing wavelet coefficients with reference to visual weights according to channel capacity according to an embodiment of the present invention and when transmission is performed according to the conventional SPIHT algorithm. In FIGS. 10 and 11, the x-axis represents a weighted channel capacity normalized by C_{ω}^{T}.

Referring to FIG. 10, according to the image coding method of an embodiment of the present invention, the transmitted volume of the visual entropy is rapidly increased at low channel capacity and gradually converges with the conventional technique at a channel capacity of 1. Referring to FIG. 11, it can be reconfirmed that the visual entropy gain is relatively higher when using the image coding method of an embodiment of the present invention rather than using the conventional SPIHT algorithm. In FIG. 11, the visual entropy gain rapidly increases up to about 0.23 at a channel capacity of about 0.1. In the channel capacity range from 0.1 to 0.45, the attained gain is greater than that of the conventional SPIHT algorithm by about 0.2.

According to the present invention, wavelet coefficients are sequentially coded and transmitted according to visual weights generated in consideration of a HVS feature in frequency and spatial domains, so that an image with further improved visual quality can be coded and transmitted at low channel capacity.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

While the present invention has been particularly shown and described with reference to exemplary embodiments thereof it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An image coding method comprising:
generating wavelet transform coefficients, by transforming an input image;
generating visual weights of the wavelet transform coefficients in consideration of a sensitivity of a human visual system (HVS) in spatial and frequency domains;
determining a coding order of the wavelet transform coefficients by using the generated visual weights; and
coding the wavelet transform coefficients according to the determined coding order.

2. The image coding method of claim 1, wherein the generating of visual weights of the wavelet transform coefficients further comprises:
determining a spatial domain weight ωₘ^{s} of the wavelet transform coefficients by using a local bandwidth normalized according to a region of interest of the wavelet-transformed input image;
determining a frequency domain weight ωₘ^{f} of the wavelet transform coefficients by using an error sensitivity at a subband of the wavelet-transformed input image; and
generating the visual weights by calculating the product of the spatial domain weight and the frequency domain weight.

3. The image coding method of claim 2, wherein the spatial domain weight ωₘ^{s} is determined by using a minimum value between a critical frequency f_{c} that indicates a limit of a spatial frequency visually perceivable by humans and a display Nyquist frequency f_{d} that is a maximum frequency that can be represented on a display without aliasing.

4. The image coding method of claim 3, wherein, if e is an eccentricity defined by
$${tan}^{- 1} ( \frac{d}{{N}_{v}} )$$
(here, N is the total number of pixels, v is a distance existing between the eye and an image and normalized according to an image size, and d is a distance between a pixel position in association with the wavelet transform coefficients and a foveation point), CT₀ is a minimal contrast threshold, α is a spatial frequency decay constant, and e₂ is a half-resolution eccentricity constant, then the critical frequency f_{c} is defined by
$${f}_{c} = \frac{{e}_{2 } ln ( \frac{1}{C {T}_{0} } )}{α ( e + {e}_{2} )} ,$$
the display Nyquist frequency f_{d} is defined by
$${f}_{d} = \frac{π N v}{360} ,$$
and if a minimum value between the critical frequency f_{c} and the display Nyquist frequency f_{d} is defined as a local frequency fₘ (m is a wavelet coefficient index) over a wavelet domain, the spatial domain weight ωₘ^{s} is defined by
$${ω}_{m}^{s} = {( \frac{{f}_{m}}{max ( {f}_{m} )} )}^{2} .$$

5. The image coding method of claim 2, wherein the frequency domain weight ωₘ^{f} has a normalized value of an error sensitivity S_{ω}(λ,θ) at a subband to which the wavelet coefficients belong, where λ is a wavelet decomposition level, and θ is an index representing a wavelet subband.

6. The image coding method of claim 5, wherein the error sensitivity S_{ω}(λ,θ) has a normalized value of the inverse of an error detection threshold T_{λ,θ}, defined by
$${T}_{λ , θ} = \frac{{Y}_{λ , θ}}{{A}_{λ , θ}} = \frac{{α10}^{k ( {log ( {2}^{1} {f}_{o} {g}_{θ} / r )}^{2} )}}{{A}_{λ , θ}} ,$$
of the wavelet coefficients, where A_{λ,θ} is a basis function amplitude, f is a spatial frequency (cycles/degree), and g_{θ}, fₒ, and k are constants.

7. The image coding method of claim 2, wherein the determining of a coding order of the wavelet transform coefficients comprises:
calculating the total number of wavelet coefficients that can be transmitted with the current channel capacity, by using a current channel capacity and differential entropy of the wavelet coefficients; and
selecting for transmission as many wavelet transform coefficients as the total number of the wavelet coefficients in the order of the magnitudes of the generated visual weights.

8. The image coding method of claim 2, wherein a region of interest of the input image is determined by motion detection as an image region in which a motion or action is very likely to be perceived, or is determined by tracking an observer's pupil movement, or is determined by a user's selection.

9. An image coding apparatus comprising:
a transformer generating wavelet transform coefficients by transforming an input image;
a visual weight generator generating visual weights of the wavelet transform coefficients in consideration of a sensitivity of a human visual system (HVS) in spatial and frequency domains;
a coding order determining unit determining a coding order of the wavelet transform coefficients by using the generated visual weights; and
a sequential wavelet coefficient coder coding the wavelet transform coefficients according to the determined coding order.

10. The image coding apparatus of claim 9, wherein the visual weight generator comprises:
a spatial domain weight determining unit determining a spatial domain weight ωₘ^{s} of the wavelet transform coefficients by using a local bandwidth normalized according to a region of interest of the wavelet-transformed input image;
a frequency domain weight determining unit determining a frequency domain weight ωₘ^{f} of the wavelet transform coefficients by using an error sensitivity at a subband of the wavelet-transformed input image; and
a multiplying unit generating the visual weights by calculating the product of the spatial domain weight and the frequency domain weight.

11. The image coding apparatus of claim 10, wherein the spatial domain weight ωₘ^{s} is determined by using a minimum value between a critical frequency f_{c} that indicates a limit of a spatial frequency visually perceivable by humans and a display Nyquist frequency f_{d} that is a maximum frequency that can be represented on a display without aliasing.

12. The image coding apparatus of claim 11, wherein, if e is an eccentricity defined by
$${tan}^{- 1} ( \frac{d}{{N}_{v}} )$$
(here, N is the total number of pixels, v is a distance existing between the eye and an image and normalized according to an image size, and d is a distance between a pixel position in association with the wavelet transform coefficients and a foveation point), CT₀ is a minimal contrast threshold, α is a spatial frequency decay constant, and e₂ is a half-resolution eccentricity constant, then the critical frequency f_{c} is defined by
$${f}_{c} = \frac{{e}_{2 } ln ( \frac{1}{C {T}_{0} } )}{α ( e + {e}_{2} )} ,$$
the display Nyquist frequency f_{d} is defined by
$${f}_{d = } \frac{π N v}{360} ,$$
and if a minimum value between the critical frequency f_{c} and the display Nyquist frequency f_{d} is defined as a local frequency fₘ (m is a wavelet coefficient index) over a wavelet domain, the spatial domain weight ωₘ^{s} is defined by
$${ω}_{m}^{s} = {( \frac{{f}_{m}}{max ( {f}_{m} )} )}^{2} .$$

13. The image coding apparatus of claim 10, wherein the frequency domain weight ωₘ^{f} has a normalized value of an error sensitivity S_{ω}(λ,θ) at a subband to which the wavelet coefficients belong, where λ is a wavelet decomposition level, and θ is an index representing a wavelet subband.

14. The image coding apparatus of claim 13, wherein the error sensitivity S_{ω}(λ,θ) has a normalized value of the inverse of an error detection threshold T_{λ,θ}, defined by
$${T}_{λ , θ} = \frac{{Y}_{λ , θ}}{{A}_{λ , θ}} = \frac{α {10}^{k ( {log ( {2}^{1} {f}_{o} {g}_{θ} / r )}^{2} )}}{{A}_{λ , θ}} ,$$
of the wavelet coefficients, where A_{λ,θ} is a basis function amplitude, f is a spatial frequency (cycles/degree), and g_{θ}, fₒ, and k are constants.

15. The image coding apparatus of claim 9, wherein the coding order determining unit calculates the total number of wavelet coefficients that can be transmitted with the current channel capacity by using a current channel capacity and differential entropy of the wavelet coefficients, and selects for transmission as many wavelet transform coefficients as the total number of wavelet coefficients in the order of the magnitudes of the generated visual weights.

16. The image coding apparatus of claim 9, further comprising a region of interest determining unit determining a region of interest by motion detection as an image region in which a motion or action is very likely to be perceived, or by tracking an observer's pupil movement, or by a user's selection.

17. An image decoding method comprising:
decoding wavelet transform coefficients coded in the order of the magnitudes of visual weights generated in consideration of a sensitivity of a human visual system (HVS) in spatial and frequency domains;
performing an inverse wavelet transform on the decoded wavelet transform coefficients; and
reconstructing an image by using the inverse-wavelet-transformed coefficients of each subband.

18. The image decoding method of claim 17, wherein the visual weight is determined as the product between a spatial domain weight ωₘ^{s}, which is determined by using a minimum value between a critical frequency f_{c} that indicates a limit of a spatial frequency visually perceivable by humans and a display Nyquist frequency f_{d} that is a maximum frequency that can be represented on a display without aliasing, and a frequency domain weight ωₘ^{f} having a normalized value of an error sensitivity S_{ω}(λ,θ) at a subband to which the wavelet coefficients belong, where λ is a wavelet decomposition level, and θ is an index representing a wavelet subband.

19. An image decoding apparatus comprising:
a sequential wavelet coefficient decoder decoding wavelet transform coefficients coded in the order of the magnitudes of visual weights generated in consideration of a sensitivity of a human visual system (HVS) in spatial and frequency domains;
an inverse transformer performing an inverse wavelet transform on the decoded wavelet transform coefficients; and
an image reconstruction unit reconstructing an image by using the inverse-wavelet-transformed coefficients of each subband.

20. The image decoding apparatus of claim 19, wherein the visual weight is determined as the product between a spatial domain weight ωₘ^{s}, which is determined by using a minimum value between a critical frequency f_{c} that indicates a limit of a spatial frequency visually perceivable by humans and a display Nyquist frequency f_{d} that is a maximum frequency that can be represented on a display without aliasing, and a frequency domain weight ωₘ^{f} having a normalized value of an error sensitivity S_{ω}(λ,θ) at a subband to which the wavelet coefficients belong, where λ is a wavelet decomposition level, and θ is an index representing a wavelet subband.
